(19) United States
(12) Patent Application Publication
(10) Pub. No.: US 2003/0095312 A1
(43) Pub. Date: May 22, 2003

(54) Common clock optical fiber transmission system

(75) Inventors: Thierry Zami, Massy (FR); Arnaud Dupas, St-Michel-Sur-Orge (FR); Olivia Rofidal, Bure Sur Yvette (FR)

Correspondence Address: SUGHRUE MION, PLLC, 2100 Pinnsylvania Avenue, N.W., Suite 800, Washington, DC, 20037-3213, US

(73) Assignee: ALCATEL

(21) Appl. No.: 10/292,453

(22) Filed: Nov. 13, 2002

(30) Foreign Application Priority Data
Nov. 22, 2001 (FR) 0115108

(51) Int. Cl. H04B 10/00; H04B 10/02

(52) U.S. Cl. 359/158; 359/176

(57) ABSTRACT

An optical system includes a first device for regenerating a plurality of electrical or optical signals (211, 213, 215, 217) in the form of a composite optical signal (235) including a plurality of wavelengths, the first device including a plurality of optical modulators (210, 212, 214 and 216) and a multiplexer (230) for multiplexing the signals supplied by the modulators, each of the modulators having an input (219) for the signals and a clock input (221), and a second device for regenerating the composite optical signal in the form of a plurality of electrical or optical signals, the second device including means for demultiplexing the plurality of wavelengths and a plurality of regenerators each having a clock input and a data output for reproducing an electrical signal. A first clock circuit (220) is common to all the clock inputs of the first device and a common second clock circuit is common to all the clock inputs of the second device.

The present invention relates generally to the technology of optical fiber transmission and more particularly to a common clock optical transmission system which reduces the cost of implementing optical converters in a transmission mode in which many wavelengths organized into bands of wavelengths are transported together in an optical fiber network.

### BACKGROUND OF THE INVENTION

For years network operators have been investing in transporting information (voice and data) in optical form because of the inherent advantages of transmission via fibers. In particular, backbone networks have had their transport capacity significantly increased by adopting a technique known as dense wavelength division multiplexing (DWDM). This technique enables different wavelengths to be transmitted on the same fiber, thereby multiplying the number of completely independent transmission channels on the same physical fiber. Tens of wavelengths, or even hundreds of wavelengths, can therefore be combined and transported in the same propagation medium.

An essential function in such networks is then the ability to direct and orient to their final destination streams of information transported in the form of modulation of various wavelengths. Among other things, this is achieved by optical switches (100), as shown in the FIG. 1 functional block diagram. As a general rule these devices are able to direct any stream received at one of the input interfaces, for example the interface (110), to any output interface, for example the interface (120). Each input or output interface has to be synchronized by a device supplying a clock signal. However, the practical implementation of these devices is costly, in particular because these interfaces must combine new optical technologies with conventional electronics technologies, which are still necessary.

Another essential function is the ability to transmit over long distances. U.S. Pat. No. 4,267,590 describes a transmission system which includes:

senders which receive a electrical data signals and modulate respective optical signals having different wavelengths and then spectrally multiplex them into a composite optical signal,

a transmit optical fiber,

a demultiplexer for demultiplexing said composite optical signal into a plurality of optical signals, and

receivers each connected to a respective output of the demultiplexer.

The senders are synchronized by respective phase-shifted clock signals supplied by a common clock connected to a cascade of phase shifters. Each receiver receives only one of the demultiplexed optical signals and is individually synchronized by a synchronization device including a clock signal acquisition circuit receiving the optical signal.

### OBJECT AND SUMMARY OF THE INVENTION

The object of the invention is to provide an optical fiber transmission system using a common clock both in the transmitting portion and in the receiving portion, thereby reducing the cost of implementing the system.

The invention therefore provides an optical fiber transmission system, in particular an optical switch, including:

a first device for regenerating a plurality of electrical or optical signals in the form of a composite optical signal including a plurality of wavelengths,

a first clock circuit for supplying a common clock signal for regenerating said electrical or optical signals, and

a second device for regenerating said composite optical signal in the form of a plurality of electrical or optical signals, said second device comprising means for demultiplexing said plurality of wavelengths and a plurality of regenerators connected to respective outputs of said demultiplexer means, each regenerator having a clock input and a data output for reproducing a regenerated signal,

which system is characterized in that said regenerator second device comprises a common second clock circuit for supplying a clock signal to each of said regenerators and clock signal acquisition means common to all the regenerators of the regenerator second device and connected to an output of said demultiplexer means and to an input of said common second clock circuit.

### BRIEF DESCRIPTION OF THE DRAWINGS

Objects, features, advantages and the subject matter of the invention will emerge more clearly from the following detailed description of a preferred embodiment of the invention, which is illustrated by the accompanying drawings, in which:

FIG. 1 is a functional block diagram of an optical switch which constitutes an optimum application of the invention.

FIG. 2 shows the sending portion of an optical transmission system according to the invention.

FIG. 3 shows the receiving portion of an optical transmission system according to the invention.

FIGS. 4A, 4B and 4C show the decorrelation of bitstreams transmitted on adjacent channels.

FIG. 5 is a diagram showing the time shift between signals on adjacent channels.

### MORE DETAILED DESCRIPTION

The invention exploits the fact that the optical signals used to transport information are organized into bands combining a plurality of wavelengths or individual transmission channels. This kind of organization achieves a high capacity for switching information at reasonable cost, responding to the ever increasing demand for telecommunication network bandwidth.

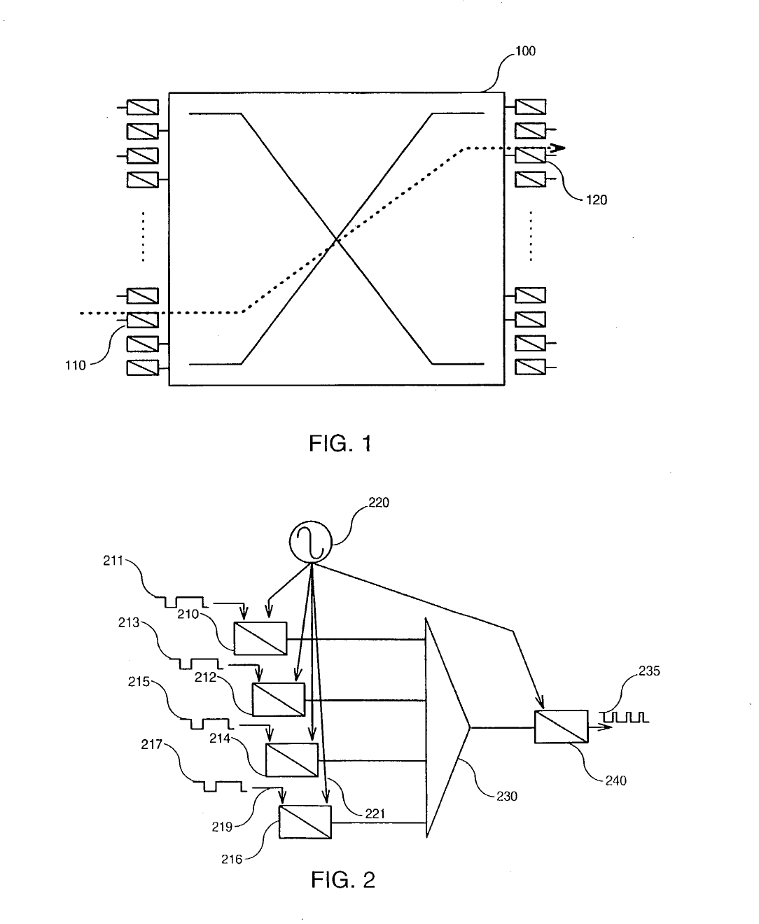

Thus FIG. 2 shows by way of example a band containing four wavelengths which are combined to be transported simultaneously to the point of utilization, thereby traveling over exactly the same path and passing through the same equipment units, in particular one or more optical switches of the type shown in FIG. 1. This transmission mode is known as wavelength banding division multiplexing (WBDM). Accordingly, in this transmission mode, the four optical modulators (210, 212, 214 and 216) necessary for modulating the four wavelengths of the band to be transmitted as a function of four corresponding electrical signals (211, 213, 215 and 217) use the same clock source (220) and are therefore perfectly synchronized for sending. Although the invention is described here with reference to modulation based on electrical signals, it must be understood that the signals could equally well be optical signals.

In this particular example for illustrating the invention, each modulator therefore has an input for the modulating electrical signal (219) and a clock input (221). Note that the modulation is preferably of the non-return to zero (NRZ) type, which is the simplest to use with binary electrical signals. Once modulated, the four wavelengths are optically multiplexed in an appropriate standard device (230), for example an optical coupler. The common clock (220) can also be used to add common RZ modulation (240) to facilitate detection of the signal at the receiving end, although this is in no way essential for proper implementation of the invention.

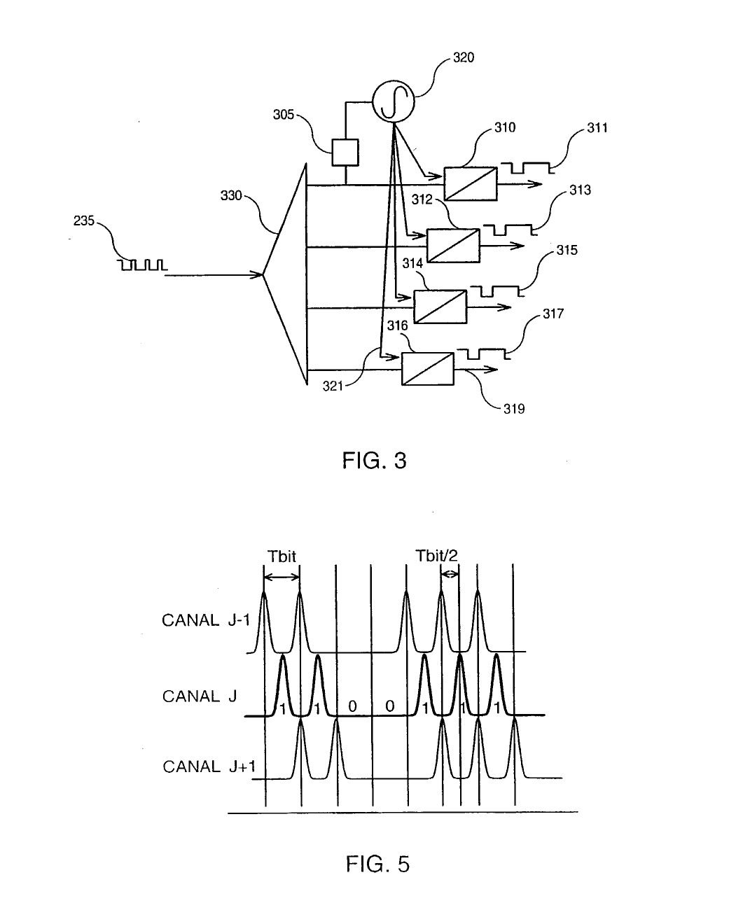

Then, as shown in FIG. 3, when the transmitted signal (235) is received, the individual channels forming the band of wavelengths are demultiplexed in a standard optical device (330), such as a wavelength splitter. One of the channels is then selected, for example the top channel, and its signal is passed to acquisition means (305) from which the send clock is extracted so that it can be used, subject to an appropriate time shift, for the four channels of the band of wavelengths of this particular embodiment of the invention. The signals that modulated the optical signals can then be reproduced (311, 313, 315 and 317) at the output of the four regenerators (310, 312, 314 and 316) using, as for sending, a single clock source (320), each optical-electrical converter having for example an output (319) and a clock input (321).

Thus the invention shares a single clock for sending and receiving, helping to reduce the cost of implementing the function.

However, it will noted that implementing the invention implicitly assumes that the chromatic dispersion of the optical signals transmitted through the various devices necessary for routing the signals to their final destination is low, so that the common clock can sample the received optical signals effectively and without error. This depends in particular on using switches of the FIG. 1 type incorporating chromatic dispersion compensation, which is a technique known to the person skilled in the art.

Furthermore, persons skilled in the art of optical transmission know that transporting information by modulating closely spaced wavelengths, as in the case of WBDM, can induce undesirable parasitic phenomena; for example, parasitic cross-modulation between channels can occur. These phenomena, which occur in the type of optical switch shown in FIG. 1 in particular, especially with the necessary use of semiconductor optical amplifiers (SOA), are known to the person skilled in the art as cross-gain modulation (XGM) or four wave mixing (FWM). They are more accentuated if the data conveyed on adjacent channels is identical. As a general rule, even if the data transported on adjacent channels is different, it is nevertheless not uncommon for the data transported in fact to be identical over greater or longer periods. In particular, message headers often have common parts that are repeated regularly and which can be in phase between two adjacent channels.

Moreover, effective use of the transmission channels achieves their full capacity only under exceptional circumstances. It is then standard practice to send pseudo-packets with no data in them, instead of real data packets, to maintain the synchronization between the communication equipment units. The empty packets always have the same format and the receiver can recognize them. They are simply ignored by the receiver once they have fulfilled their one function of maintaining link synchronization. Thus a significant portion of the information transmitted by adjacent channels can be identical, especially if the transmission channels are underused and therefore carry many empty packets.

In this case, because of an excessively high bit error rate (BER) on the links, the parasitic cross-modulation mentioned above can reach a level incompatible with correct implementation of the invention. As shown in FIGS. 2 and 3, the invention assumes that the signals transported are perfectly synchronized to enable the use of a common clock, which can only exacerbate the unwanted phenomena described. Accordingly, to obtain the full benefit of the invention, it is necessary to decorrelate the bitstreams transmitted on adjacent channels.

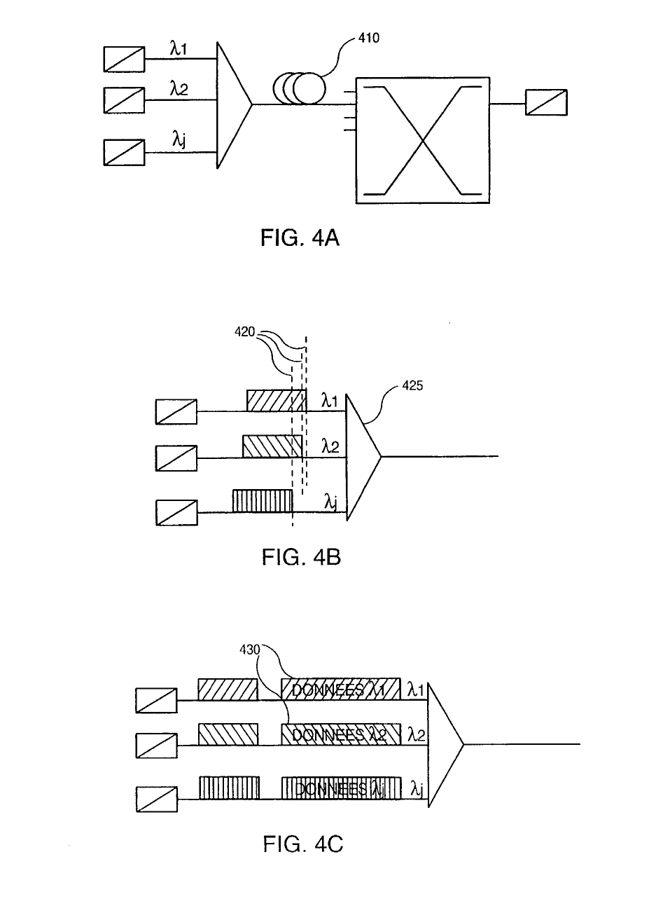

FIGS. 4A, 4B and 4C show three methods of obtaining the required effect. FIG. 4A shows decorrelation obtained at the optical level by introducing an optical fiber (410) of sufficient length (several kilometers), which creates a time shift between adjacent channels because of chromatic dispersion.

The FIG. 4B device obtains the same effect by introducing time-delays between adjacent channels at the electrical level (420) before mixing (425) the wavelengths constituting the band of wavelengths. The time shift D between two adjacent channels j and j−1 is a real number multiple αⱼ of the bit time Tbit defined as follows: Dⱼ-Dⱼ₋₁=αⱼTbit.

In the case of RZ modulation, the return of the power to zero between two symbols can be exploited. When the remainder of dividing the time shift between adjacent channels by the bit time is equal to half a bit time (αⱼ=0.5), a channel j is at its maximum power when the adjacent channels j+1 and j−1 are at their minimum power (see FIG. 5). Because of the diversity of the FWM components in a WDM context, the effective range of the time shift between channels is widened in accordance with the following equation: αᵢ=n+ε, where n is an integer and ε is a real number from 0.25 to 0.75.

In FIG. 4C, the decorrelation of the bitstreams is simply obtained by inverting (430) the transmitted data between adjacent channels so that the data takes opposite values during transmission but is re-established on reception.

What is claimed is:

1. An optical fiber transmission system, in particular an optical switch, including:
a first device for regenerating a plurality of electrical or optical signals (211, 213, 215, 217) in the form of a composite optical signal (235) including a plurality of wavelengths,
a first clock circuit (220) for supplying a common clock signal for regenerating said electrical or optical signals, and
a second device for regenerating said composite optical signal (235) in the form of a plurality of electrical or optical signals (311, 313, 315, 317), said second device comprising means for demultiplexing (330) said plurality of wavelengths and a plurality of regenerators (310, 312, 314, 316) connected to respective outputs of said demultiplexer means, each regenerator having a clock input (321) and a data output (319) for reproducing a regenerated signal,
which system is characterized in that said regenerator second device comprises a common second clock circuit (320) for supplying a clock signal to each of said regenerators and clock signal acquisition means (305) common to all the regenerators of the regenerator second device and connected to an output of said demultiplexer means (330) and to an input of said common second clock circuit (320).

2. A system according to claim 1, characterized in that it further includes means for compensating chromatic dispersion of said plurality of wavelengths.

3. A system according to claim 1, characterized in that it includes means (410, 420) for decorrelating sequences of data used to modulate said wavelengths before switching them.

4. A system according to claim 3, characterized in that the decorrelator means include a non-zero chromatic dispersion optical fiber (410) for applying an optical time-delay to said composite optical signal.

5. A system according to claim 3, characterized in that the decorrelator means include electrical means for delaying (420) one or more of the bitstreams used to modulate said wavelengths.

6. A system according to claim 3, characterized in that the decorrelator means include means for inverting (430) the bitstream used to modulate said wavelengths.

7. A system according to claim 3, characterized in that said decorrelation is always synchronous with a clock of the regenerator first device.

8. A system according to claim 4, characterized in that said time shift is greater than n+0.25 bit periods and less than n+0.75 bit periods, where n is an integer.
